(19) United States
(12) Patent Application Publication
(10) Pub. No.: US 2009/0282839 A1
(43) Pub. Date: Nov. 19, 2009

(54) APPARATUS AND METHOD OF STORING AND TRANSPORTING A GAS

(76) Inventor: Richard F. Sigal, Moore, OK (US)

Correspondence Address: DUNLAP CODDING, P.C., PO BOX 16370, OKLAHOMA CITY, OK, 73113, US

(21) Appl. No.: 12/466,764

(22) Filed: May 15, 2009

Related U.S. Application Data
(60) Provisional application No. 61/127,739, filed on May 15, 2008.

(51) Int. Cl. F17C 11/00; F17C 13/00

(52) U.S. Cl. 62/46.3; 206/7

(57) ABSTRACT

An apparatus and method for storing a gas at about room temperature and at a predetermined pressure. The apparatus comprising a storage vessel and a nano-porous media having a plurality of nano-pores and a large specific surface area. The nano-porous media is saturated with a host liquid and gas is brought into contact with the host liquid whereby the gas is caused to be dissolved into the host liquid.

### CROSS REFERENCE TO RELATED APPLICATIONS

This application claims benefit of U.S. Provisional Application No. 61/127,739, filed May 15, 2008, which is incorporated herein by reference in its entirety.

### BACKGROUND OF THE INVENTION

1. Field of the Invention

The present invention relates to a method of storing and transporting various kinds of gases including natural gas, methane, ethane, and other lower hydrocarbons, and hydrogen. More particularly, but not by way of limitation, it relates to a method of storing and transporting these gases through dissolving a large quantity of gas in fluid that fills the pores of a nano-porous material.

2. Brief Description of Related Art

Various methods for the storage and transportation of gas are currently in use. The method depends on the type of gas, the end usage of the gas and the location of the gas source. For natural gas used for electrical power generation, heating, or chemical feed stock and for which a pipeline can be built to connect the gas source with the end use location, transportation is done by pipeline and when necessary storage can be done in underground reservoirs. Alternative methods are needed when the gas is not connected by a pipeline to the end use location, the end use requires storage in a portable system, or as is the case for hydrogen the gas diffuses at too high a rate through standard storage tank and pipeline materials. Gas in a gaseous state at standard temperature and pressure has low density, so practical storage and/or transportation in a storage tank requires greatly increasing the number of gas molecules stored per volume of storage material. Currently the primary methods of storing and transporting gas in storage tanks are: (1) compressing gas under a high pressure as seen in the case of compressed gas contained in high pressure gas bombs; and (2) cooling and liquefying gas as seen in the case of liquid nitrogen, and liquid oxygen, or liquefied natural gas and the like.

However, each method has its drawback. With respect to compressing gas, this method has a drawback in that the weight of storage vessels becomes very large in comparison to the weight of the gas to be stored because sufficient pressure-resistant strength is required of vessels. In addition, materials, facilities, piping, and the like meeting specifications specified under the regulations pertaining to high pressure gas control are required, causing the method to become costly as a result.

With respect to liquefaction, the gas must be compressed and cooled for the liquefaction thereof, thereby resulting in a high cost but also requiring separate and special facilities to keep the liquefied gas cooled. Furthermore, similarly to the compressing method, this method is subject to regulatory constraints. Under the circumstance, viable application of this method is limited to high-valued helium or liquefied natural gas in which economies of scale can be realized.

Currently natural gas can only be transported by pipeline or LNG transport. The present invention provides an alternative method for transport where the market is not reachable by pipelines, or where LNG infrastructure costs are too high for the gas available. Depending on factors, it could turn out to be cheaper or safer than LNG in all cases. Natural gas used for powering trucks or cars is currently stored as compressed gas, which along with the above stated problems, does not provide the vehicles with adequate range. The proposed storage method could provide a safer more practical method to store hydrogen or methane in cars, buses, trucks, and the like. Currently, there is no accepted method for transport and/or store of large amounts of hydrogen. This is an essential missing component of the “hydrogen economy” in which hydrogen is used to store electrical power generated from intermittent power sources such as wind or solar.

This present invention has the potential to provide a practical way to transport or store hydrogen. Storage as an adsorbed phase has been discussed for hydrogen but has not been made practical. For methane this storage will certainly be safer than high pressure tanks or LNG storage and transport. At the least it provides an alternative technology to commercialize the large amounts of stranded gas found in the world. Another alternative technology for commercializing stranded natural gas is gas to liquid technology. It has the disadvantage of converting the hydrocarbon with the smallest greenhouse gas footprint after combustion into one with a larger footprint. Gas to liquid technology is still not a practical commercial technology for most stranded gas. Depending on technology development this technology could become the preferred storage method for all gas storage from car gas tanks to super tankers.

To this end, a need exists for an improved method of storing and transporting gases. It is to such a method that the present invention is directed.

### BRIEF DESCRIPTION OF THE SEVERAL VIEWS OF THE DRAWINGS

FIG. 1 is a cutaway, side elevational view of a vessel holding a nano-porous media, in accordance with the present invention.

FIG. 2 is a schematic diagram of an apparatus for storing a gas.

FIG. 3A is a flowchart of a method of storing gas utilizing a nano-porous media.

FIG. 3B is a flowchart of an alternative method of storing gas utilizing a nano-porous media.

### DETAILED DESCRIPTION OF EXEMPLARY EMBODIMENTS

The solubility of methane in water is generally reported from experiments done in macroscopic pressure cells. A simple calculation with physically reasonable assumptions shows that in very small pores the amount of methane dissolved in the pore water approaches the amount of methane that would be contained in that pore if it was filled with methane at several thousand psi. Under some assumptions the effective storage in the pore is almost equal to the number of molecules of methane that could be stored in a liquid state in the pore.

This calculation is consistent with other observations that porous media phase equilibrium conditions depend on the pore geometry. For example, the freezing point of water is suppressed in small pores, so that electrical logs through permafrost shale zones appear conductive but the sands are very resistive. It is also consistent with gas storage in gas hydrates where the gas is held in molecular cages so that at relatively low pressures at temperatures below 0° C. the stored gas is equal to the amount of gas that could be stored in the same volume at several thousand psi.

The solubility of methane in brine given in the standard tables has been established through measurements in macroscopic pressure cells. In the argument that follows simple but reasonable approximations are used to show that in very small pores CH₄ solubility must be somewhat larger than the macroscopic measurement values. In fact the mass of gas per unit volume of brine that is contained in a very small brine filled pore could approach the amount of gas that could be stored in the pore at several thousand psi. In the argument below the pore walls are assumed to be strongly water wet. In a nano-porous media it is well known that significant gas can also be stored as adsorbed gas. To achieve maximum storage using both storage mechanisms there will be an optimum wall wettability that will depend on the pore wall material, the fluid, the type of gas, and the pore geometry of the nano-material. This argument is based on the assumption that it takes a minimum number of gas molecules for the aggregate to behave like a classical fluid with a surface tension, and from the definition of solubility when a solution is minimally super saturated the number of gas molecules in the aggregate must be only a small percentage of the number of gas molecules in solution.

The solubility at a given temperature and pressure of methane in water is defined as the maximum saturation of CH₄ that the water can hold. At this saturation any small decrease in pressure or addition of more gas molecules will lead to a drop (bubble) of gas forming in the solution. When the CH solution is confined to a small container a limited amount of gas is available to form the CH₄ drop. This combined with the conditions that the gas drop has a minimum size and the initial drop formed must contain only a small fraction of the total amount of gas leads to the increase in solubility. The minimum size follows from the need for the gas drop to contain enough molecules to behave as a separate phase with a well defined surface.

For a spherical drop of gas in a brine solution the gas pressure P_{g} is related to the water pressure P_{w} by Eq. 1.

P_{g}=P_{w}+2γ/r_{b} (1)

where γ is the gas water surface tension and r_{b} is the radius of the gas drop. The second term is referred to as the capillary pressure. Using a common equation of state for gas the gas pressure in the drop is given by

P_{g}=z(n_{b}/V_{b})RT (2)

where z is the compressibility factor, n_{b} is the number of moles of CH₄ contained in the drop, V_{b} the volume of the spherical drop, R the universal gas constant and T is the absolute temperature [W. McCain, Petroleum Fluids (PennWell Books Tulsa 1990]. The compressibility factor z is a function of pressure and temperature but can be evaluated numerically using commercially available computer codes. For this work the NIST program Supertrap was used to evaluate z.

Combining Eqs. 1 and 2 gives

n_{b}=((4/3)πr_{b}³/zRT)(P_{w}+2γ/r_{b}) (3)

The moles of gas in the methane drop are sourced from the CH₄ in solution with the water. Before the formation of the first gas drop the brine had a saturation of ρₛᵢ moles of methane per unit volume. After the formation of the first gas drop its saturation is ρₛ, where ρₛ is the solubility of methane in brine at P_{w} and T. The supersaturated value ρₛᵢ and the saturated value pₛ can be related by Eq. 4.

ρₛᵢ=(1+α)ρₛ, (4)

In Eq. 4 α<<1 and is positive as after the formation of the gas drop the methane in the drop is in equilibrium with the methane in solution which forces the saturation to be ρₛ and before the formation of the drop the solution could be arranged to be minimally supersaturated.

Eq. 4 implies that for a container of volume Vₚ

n_{b}=αρₛ Vₚ (5)

This leads to Eq. 6 which provides an equation to estimate the solubility of CH₄ in brine in a small pore.

ρₛ=((4/3)πr_{b}³/zRTαVₚ)(P_{w}+2γ/r_{b}) (6)

Examination of Eq. 6 shows that the ρₛ increases with increasing r_{b} and decreasing α. The value of r_{b} must be large enough for the gas in the drop to behave like a single phase fluid with a well defined surface tension.

The critical point for methane is a (−82.6° C., 666 psi (4.59 mPa)). At this point liquid methane has a density of 0.029 moles/cm³ (0.464 g/cm³). Methane gas at 20,000 psi (138 mPa) and room temperature has a density of 0.023 moles/cm³ (0.368 g/cm³). The liquid density provides a reasonable upper limit to how closely methane molecules can be packed in the gas drop. At this density a 0.5 nm radius sphere contains 9 molecules, a 1.0 nm radius sphere contains 73 molecules, and a 2.0 nm radius sphere 584 molecules of CH₄. Nine molecules are almost certainly too few to form an independent gas phase and 584 should be more than adequate. This implies that the minimum drop size is on the order of one nanometer.

In the low pressure limit the gas pressure in the drop is given by the second term in Eq. 1. To evaluate this requires a value for γ. Under room temperature γ is essentially independent of pressure and has a value of 70 dynes/cm [T. Schowalter, AAPG Bulletin, V.63, No. 5 (1979)]. At 20° C. and standard atmospheric pressure, 2γ/r_{b} for a one nm spherical drop has a value of 20,300 psi (140 mPa). At this pressure z has a value of 2.46. Using Eq. 3 a gas drop one nm in radius has 58 molecules. For this case the solubility estimate calculated from Eq. 6 increases with the square of the gas drop radius, so using a one nm radius drop should at the worst underestimate the value.

The more difficult parameter to estimate is α. There is not an obviously easily way to provide a good bound on it. By the definition of solubility ρₛᵢ−ρₛ should be approximated by a differential in the limit of large water and gas volumes. For an under saturated system the CH₄ molecules on the average will be uniformly distributed. There will though be statistical fluctuations in CH₄ density. As the saturation approaches the supersaturated state these density fluctuations provide the nuclei for the formation of gas drops. The larger the value of α the larger percentage of the CH₄ molecules that have to be contained in a single density fluctuation. For α of 0.1, 10% of the available CH₄ would have to be contained in a single density fluctuation. Using the equations developed in this calculation, for pore sizes in the 50 nanometer range at 4000 psi (27.6 mPa) water pressure an α value of 0.01 produces a solubility less that the bulk value). This implies that α must be smaller than 0.01 for this pore size. This suggests that a value of 0.01 for α should not be unreasonable for pores in the 10 nanometer size range. Table 1 shows solubility calculated for a range of pore sizes under the assumption of r_{b}=1 nm (one nm drop size) and α=0.01.

Table 1 shows the very strong dependence that this estimate of methane solubility ρₛ (g/cm³) has on the size of the pore radius. As the pore size increases the solubility can decrease as it is less constrained by the number of molecules needed to form a gas drop. For a pore radius of 5 nm the calculated solubility estimate is 0.30 g/cm³. The density of liquid methane is 0.46 g/cm³ and the density of CH₄ at 9000 psi (62.1 mPa) and 20° C. is 0.3 g/cm³. That is the calculated solubility estimate provides a methane density for this pore size that is approximately the same as the methane density that would be achieved for a pore filled with gas under very high pressure and not too much less than the density of a pore filled with liquid methane.

TABLE 1

| Pore | | | | |
|---|---|---|---|---|
| Radius (nm) | Vₚ (nm³) | r_{b} (nm) | α | ρₛ (g/cm³) |
| 5 | 524 | 1 | .01 | .30 |
| 10 | 4190 | 1 | .01 | .037 |
| 15 | 14,143 | 1 | .01 | .011 |
| 20 | 33,524 | 1 | .01 | .0046 |

ρₛ is an estimated lower bound on the solubility of methane in brine for the different listed pore volumes Vₚ. The calculation assumes atmospheric pressure and a temperature of 20° C.

The calculation done here is only based on the requirement of a minimum number of gas molecules being available to form a drop of gas and that the pore walls are hydrophilic. Solubility is actually controlled by the minimization of thermodynamic potentials. Because of this, it is quite likely that the actual enhancement of solubility is larger than calculated here and extends to larger pore sizes.

The enhanced solubility effect provides a mechanism that will allow large amounts of gas to be stored in a nano-pore. By itself it provides storability comparable or better than surface adsorption. Combined with surface adsorption it provides a way to store more gas per unit volume than can be achieved through storage under high pressure or liquefaction Practical storage requires storage in large vessels and a way to fill and empty these vessels. One way to do this is a large nano-porous solid is constructed, filled with liquid, and then placed in contact with a large gas reservoir. Given enough time, gas in the tank will diffuse into the liquid until the liquid is saturated with gas. The time scale depends on diffusion rates, which in turn depend on the individual liquid, the gas, and the pore geometry of the nano porous material. To empty the tank the gas saturated nano-porous material is placed in contact with a large empty reservoir. As gas exits from solution the gas is removed. Given enough time all the gas will come out of solution. A process such as this could be practical for some applications such as transportation of stranded gas, but for most applications would be too slow. The basic problem is that diffusional processes in nano-porous media are slow. To increase the rate of filling or emptying the surface of the nano-porous storage media has to have a large contact area with the gas reservoir. This can be accomplished by a modular design where each nano-porous module is small. That is depending on the exact use of the system, and the materials it is constructed from module dimensions should be on the order of centimeters to micrometers. The modules are assembled so that a branching network of passageways of various sizes provides gas access to each module. This system is analogous to the way blood is distributed to cells in the human body. If the liquid wets the pore materials, capillary forces will keep the liquid in the nano-pores. An advantage of this storage vessel design is a structure such as this will naturally occur when small modules are packed into a large vessel.

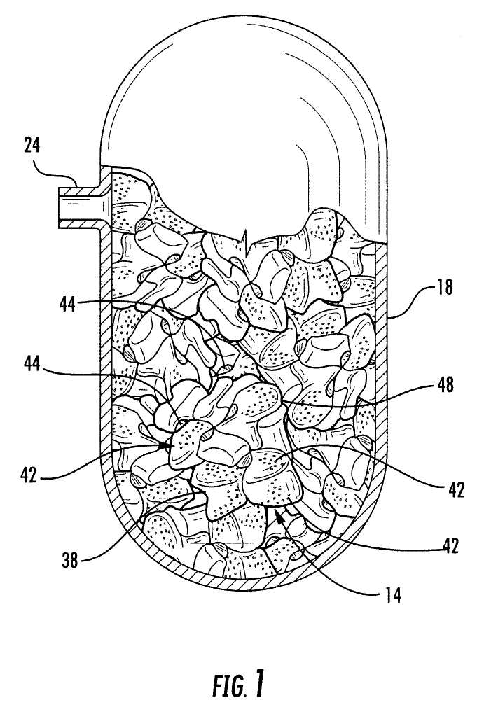

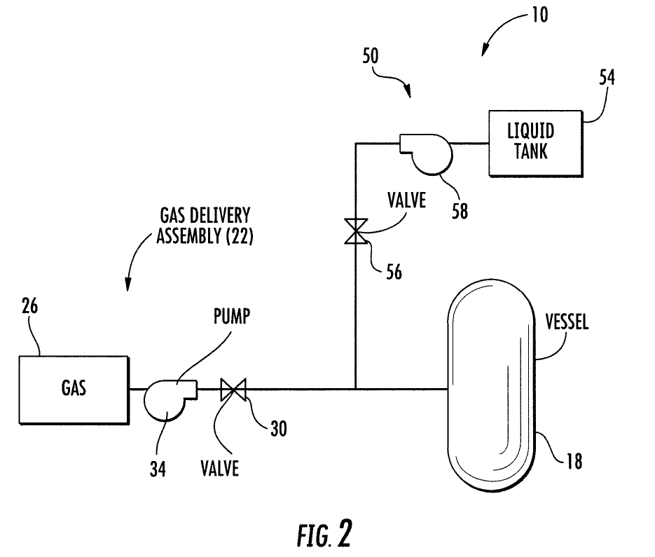

Referring now to the drawings and more particularly, to FIGS. 1 and 2 collectively, shown therein is an apparatus 10 for storing and transporting a gas within a nano-porous media 14. It will be appreciated that the drawings are not drawn to scale and certain elements are exaggerated and stylized to more clearly illustrate the principles of the present invention. The apparatus 10 includes a vessel 18 and a gas delivery assembly 22. The vessel 18 includes any number of containers capable of receiving and retaining the nano-porous media 14, a host liquid, and a gas. The vessel 18 has a port 24 and is preferably fabricated from a strong and substantially puncture resistant material such as a polymer, composite, fiberglass, titanium, alloy, carbon fiber (including carbon nanotube materials), any other suitably durable material, or any combinations thereof. It will be understood that in some applications the amount of gas that can be stored in the nano-porous media 14 can be increased by increasing the pressure within the vessel 18, therefore in such instances the vessel 18 should be constructed such that it can withstand applicable forces. Also, it will be understood that the port 24 may function as an inlet and an outlet or the vessel may be provided with a number of ports that function specifically as inlets and outlets.

The gas delivery assembly 22 includes a gas source 26, a valve 30, and an optional pump 34. The gas source 26 may be any number of devices and/or systems capable of providing a gas, such as natural gas, methane, ethane, ethylene, propane, butane, and other lower hydrocarbons, and carbon dioxide, and the like. The term “gas” as used herein is not limited to a single kind of gas but, intended to include a mixture of two or more kinds of gases, for example, natural gas and other another gas.

Examples of gas sources 26 include, but are not limited to, gas storage tanks, gas bombs (such as propane tanks), gas piping, and the like. The valve 30 may be any number of devices and/or systems capable of selectively providing fluid communication between the gas source 26 and the vessel 18 such as gate valves, poppet valves, plug valves, globe valves, check valves, butterfly valves, diaphragm valves, ball valves, needle valves, pinch valves and the like which would be known to one of ordinary skill in the art with the present disclosure before them. The pump 34 is provided to communicate the gas from the gas source 26 to the valve 30. The pump 34 may be any suitable pump or pump system that can effectively communicate a gas through pipes and/or tubes of any kind that are suitable for carrying a gas.

The gas may be introduced into the vessel 18 and allowed to dissolve into the host liquid over a period of time through physical contact between the host liquid and the gas, or may be actively dissolved into the host liquid via systems and/or process such as the ones described in, for example, U.S. Pat. No. 4,000,227, issued to Garrett; U.S. Pat. No. 4,639,340, issued to Garrett; and U.S. Pat. No. 5,049,320, issued to Wang et al., which are hereby incorporated by reference herein in their entirety. Nothing in the aforementioned examples should be interpreted as limiting as such references are only provided as examples of known methods and systems for dissolving gases into liquids.

The nano-porous media 14 includes a plurality of nano-structures 38, for example nano-tubes, a pack of nano-beads, a nano-filter material, and the like or combinations thereof. The nano-porous media 14 may be constructed of various materials having nano pores and a large specific surface area that can be used to store and transport gas, regardless of its quality, manufacturing method, and shape, provided that it neither react with nor is dissolved into water or a compound, serving as host and having a function similar to water.

The nano-structures 38 include a plurality of nano pores 42 each having a size in the nanometer range. It will be understood that there is no need for uniformity in the shape, diameter, and/or distribution of the nano pores 42 of the nano-structures 38. The nano pores 42 may be sized and shaped to receive and retain various host liquids and/or gases. Furthermore, it will be understood that the nano pores 42 may be capable of receiving and retaining various kinds of host liquids and gases having varying molecular diameters. In one embodiment, the nano structures 38 are interconnected via a plurality of pathways 44 having a permeability greater than the permeability of the nano structures 38 to facilitate the passage of gas to the nano structures 38. In one embodiment, the nano porous blocks 48 may be arranged in a regular or irregular pattern such that the areas between the nano porous blocks 48 define the pathways 44.

It will be understood that there are many possible designs for the nano-structures 38, such as an array of nano size beads, carbon nano tubes or combinations thereof. It will be further understood that the design of the nano-porous media 14 should maximize porosity and minimize weight to the extent practical. One of ordinary skill in the art will appreciate that different nano-porous media 14 designs will be optimal for different uses. Furthermore, because the design of the nano-porous media 14 is modular in nature, it may not face typical upscaling problems that exist when a single volume of nano-porous material is used, although the use of a single volume of nano-porous material may also be utilized in accordance with the present invention.

The nano-porous media 14 is disposed within the vessel 18 and saturated with a host liquid. The host liquid may be stored and delivered in a host liquid delivery sub-assembly 52. The host liquid delivery sub-assembly 52 may include a host liquid source 54, a valve 56, and a pump 58. Examples of host liquid sources 54 include, but are not limited to, liquid storage tanks, piping, and the like. The valve 56 may be any number of devices and/or systems capable of selectively providing fluid communication between the host liquid source 54 and the vessel 18 such as gate valves, poppet valves, plug valves, globe valves, check valves, butterfly valves, diaphragm valves, ball valves, needle valves, pinch valves and the like which would be known to one of ordinary skill in the art with the present disclosure before them. The pump 58 is provided to communicate the host liquid from the host liquid source 54 to the valve 56. The pump 58 may be any suitable pump or pump system that can effectively communicate a liquid through pipes and/or tubes of any kind that are suitable for carrying a liquid.

The host liquid is provided to carry a gas that has been dissolved into the host liquid. The host liquid infiltrates the nano pores 42 of the nano-structures 38 of the nano-porous media 14 and may include water, alcohols, organic acids, hydrogen sulfide, and the like, or combinations thereof. Among the examples listed, water is particularly preferable. In other embodiments, the nano-porous media 14 may be pre-saturated with the host liquid before it is disposed within the vessel 18, rather than covering the nano-porous media 14 with the host liquid.

In either case, the gas is provided into the vessel 18 via the gas delivery assembly 22 and contacts the host liquid, dissolving the gas into the host liquid. Examples of gases that may be stored within the nano-porous media 14 include, but are not limited to, natural gas, methane, ethane, ethylene, propane, butane, and other lower hydrocarbons, and carbon dioxide, and the like, or combinations thereof.

The method of the present invention may be carried in several ways. For example, the nano-porous media 14 may be placed in the vessel 18 first, then the host liquid fed into the vessel 18. Thereafter, the gas to be stored and/or transported is fed into the vessel 18 via the gas delivery assembly 22. Alternatively, the nano-porous media 14 may be pre-treated with the host liquid before placing the nano-porous media 14 in the vessel 18, and then the gas or is fed into the vessel 18. It will be understood that various embodiments other than the aforesaid may be carried out provided that the theory on which the present invention is based as disclosed previously is applied.

### Method No. 1

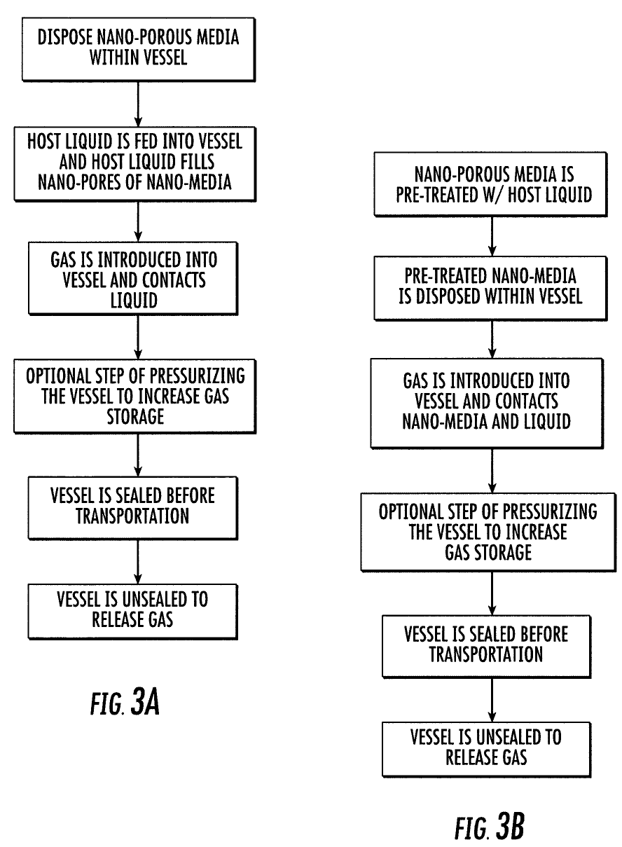

Referring now to FIG. 3A, the nano-porous media 14 is placed in the vessel 18. Next, the host liquid is fed into the vessel 18 via the host liquid delivery sub-assembly 52 until the host liquid infiltrates and saturates the nano pores 42 of the nano-structures 38 of the nano-porous media 14. Thereafter, the gas to be stored and/or transported is introduced into the vessel 18 via the gas delivery assembly 22 by operation of the pump 34 and the valve 30 which transfers the gas from the gas source 26 to the vessel 18. The gas may be allowed to dissolve into the host liquid by delivering the gas into the vessel 18 and allowing the gas and host liquid to contact one another. Additionally, the gas may be dissolved into the liquid by actively combining the gas with the host liquid. The nano pores 42 of the nano-structures 38 of the nano-porous media 14 should contact the dissolved gas/liquid solution until the nano pores 42 are saturated with the gas.

To transport the gas, the vessel 18 containing the nano-porous media 14 saturated with the gas is sealed. The vessel 18 may then be transported as needed. The gas is removed from the nano-porous media 14 by unsealing the vessel 18 to bringing it into contact with an under saturated system, for example, another vessel 18, a host liquid, or a pipe system designed to carry the gas.

### Method No. 2

Referring now to FIG. 3B, the nano-porous media 14 is pre-treated with the host liquid before placing the nano-porous media 14 in the vessel 18. The host liquid is brought into contact with the nano-porous media 14 until the host liquid infiltrates and saturates the nano pores 42 of the nano-structures 38 of the nano-porous media 14. Thereafter, the gas to be stored and/or transported is fed into the vessel 18 via the gas delivery assembly 22 by operation of the pump 34 and the valve 30 which transfers the gas from the gas source 26 to the vessel 18. The gas may be allowed to dissolve into the host liquid by delivering the gas into the vessel 18 and allowing the gas and host liquid to contact one another. Additionally, the gas may be dissolved into the liquid by actively combining the gas with the host liquid. The nano pores 42 of the nano-structures 38 of the nano-porous media 14 should contact the dissolved gas/liquid solution until the nano pores 42 are saturated with the gas.

To transport the gas, the vessel 18 containing the nano-porous media 14 saturated with the gas is sealed. The vessel 18 may then be transported as needed. The gas is removed from the nano-porous media 14 by unsealing the vessel 18 to bringing it into contact with an under saturated system, for example, another vessel 18, a host liquid, or a pipe system designed to carry the gas.

The various methods of storing and transporting gas according to the invention are effective not only under a low pressure in the range from atmospheric pressure to 10.68 atm (equivalent to 10 kg/cm 2 by gauge pressure) or less but also under a reduced pressure, for example, as low as 0.2 atm. Under a higher pressure in excess of 10.68 atm (equivalent to 10 kg/cm 2 by gauge pressure), relatively larger amounts of gas can be stored and transported relative to lower pressures. Furthermore, as the pressure increases, greater amounts of gas can be stored and transported.

Thus, the method of storing and transporting gas according to the invention does not require either any special cooling equipment or any special pressurizing facilities, making it quite effective from a practical viewpoint.

The methods of storing and transporting gas according to the invention allow for the storage and transportation of a large amount of gas using the nano-porous media 14 and the host liquid, which are available cheaply. Moreover, the method according to the invention enables a large amount of gas to be stored or transported in a short time at or close to room temperature under a reduced pressure, or a low pressure ranging from atmospheric pressure to about 10.68 atm (equivalent to 10 kg/cm² by gauge pressure) or less and is quite advantageous in practical application because it does not require, for example, any special pressure vessels and the like as required in the conventional methods.

Although in any of the embodiments of the invention described in the foregoing, high pressure vessels are not required for use as special vessels because the gas can be dissolved in the host at a low pressure, high pressure vessels may naturally be used as well without causing any problem. Therefore, it is possible to store and transport gas under a higher pressure, for example, in excess of 10.68 atm (equivalent to 10 kg/cm 2 by gauge pressure), in the same way as the method of storing and transporting gas according to the invention, in which case high pressure vessels capable of withstanding such a high pressure are used.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. An apparatus for storing a gas, comprising:
a vessel having an inlet and an outlet;
a nano-porous media disposed in the vessel, the nano-porous media having a plurality of nano pores; and
a host liquid disposed in the nano pores of the nano-porous media in such a way that the gas dissolves in the host liquid when the gas is passed through the inlet and brought into contact with the host liquid.

2. The apparatus of claim 1, further includes means for transporting the gas between the vessel and a gas source.

3. The apparatus of claim 1, wherein the nano-porous media includes a plurality nano porous structures having a plurality of nano pores, and wherein the nano pores of the nano porous structures are interconnected with nano pores of adjacent nano porous structures by pathways having a permeability greater than the permeability of the nano porous structures.

4. The apparatus of claim 3, wherein the nano-porous media is selected from the group consisting of a plurality of nano-beads, a plurality of nano-tubes, a plurality of nano-blocks, one or more nano-filters, and combinations thereof.

5. The apparatus of claim 1, wherein the host liquid is selected from the group consisting of water, alcohols, organic acids, hydrogen sulfide, and combinations thereof.

6. A method for storing a gas, comprising the steps of:
providing a vessel having a nano-porous media disposed therein, the nano porous media having a plurality of nano pores;
introducing a host liquid into the vessel to saturate at least a portion of the nano pores of the nano-porous media;
introducing the gas into the vessel so that the gas contacts the host liquid and dissolves into the host liquid; and
sealing the vessel.

7. The method of claim 6, wherein in the step of providing the vessel, the nano-porous media includes a plurality nano porous structures having a plurality of nano pores, and wherein the nano pores of the nano porous structures are interconnected with nano pores of adjacent nano porous structures by pathways having a permeability greater than the permeability of the nano porous structures.

8. The method of claim 6, further comprising the step of unsealing the vessel to release the gas from the host liquid.

9. The method of claim 6, wherein the nano-porous media is selected from the group consisting of a plurality of nano-beads, a plurality of nano-tubes, a plurality of nano-blocks, one or more nano-filters, and combinations thereof.

10. The method of claim 6, wherein the host material is selected from the group consisting of water, alcohols, organic acids, hydrogen sulfide, and combinations thereof.

11. The method of claim 6, wherein the gas is selected from the group consisting of natural gas, methane, ethane, ethylene, propane, butane, other lower hydrocarbons, carbon dioxide, hydrogen, and combinations thereof.

12. The method of claim 6, further comprising the step of transporting the vessel containing the stored gas.
